(19) United States
(12) Patent Application Publication
(10) Pub. No.: US 2012/0160686 A1
(43) Pub. Date: Jun. 28, 2012

(54) Process for separating and recovering 3-hydroxypropionic acid

(75) Inventor: Joseph Jump, Raleigh, NC (US)

(73) Assignee: NOVOZYMES NORTH AMERICA, INC., Franklinton, NC (US)

(21) Appl. No.: 13/379,572

(22) PCT Filed: Jun. 30, 2010
(86) PCT No.: PCT/US10/40613

§ 371 Date: Mar. 13, 2012

Related U.S. Application Data
(60) Provisional application No. 61/222,302, filed on Jul. 1, 2009.

(51) Int. Cl. B01D 61/44

(52) U.S. Cl. 204/537

(57) ABSTRACT

The present invention relates to processes for separating and recovering 3-hydroxypropionic acid, comprising: (a) subjecting an aqueous solution comprising a salt of 3-hydroxypropionic acid to concentrating electrodialysis to concentrate the salt of 3-hydroxypropionic acid in the aqueous solution; and (b) subjecting the resulting concentrate to bipolar membrane electro-dialysis to convert the salt of 3-hydroxypropionic acid into the free acid of 3-hydroxypropionic acid.

### BACKGROUND OF THE INVENTION

1. Field of the Invention

The present invention relates to processes for separating and recovering 3-hydroxypropionic acid in an aqueous solution comprising a salt of 3-hydroxypropionic acid.

2. Description of the Related Art

Commercial interest in producing 3-hydroxypropionic acid by fermentation has increased due to, e.g., its potential to serve as a chemical building block for the manufacture of acrylic acid, acrylamide, 1,3-propanediol, and other compounds.

Several potential metabolic routes from the renewable carbon source D-glucose to 3-hydroxypropionic acid have been proposed (WO 2002/042418, WO 2003/062173, WO 2007/042494). Various methods for separating and recovering 3-hydroxypropionic acid from an aqueous solution (e.g., fermentation broth) include, for example, acidification with a mineral acid, such as sulfuric acid, to allow recovery of the 3-hydroxypropionic acid with calcium sulfate (gypsum) as a by-product (WO 2002/090312), and extraction of 3-hydroxypropionic acid using organic solvents (WO 2002/090312, WO 2005/003074, WO 2005/021470). However, for every ton of calcium 3-hydroxyproionate produced using the gypsum process, a ton of waste salt as calcium sulfate is produced, which usually land-filled.

There is a need in the art for improved methods for separating and recovering 3-hydroxypropionic acid from an aqueous solution, e.g., fermentation broth.

The present invention provides processes for separating and recovering the free acid of 3-hydroxypropionic acid in an aqueous solution comprising a salt of 3-hydroxypropionic acid.

### SUMMARY OF THE INVENTION

The present invention relates to processes for separating and recovering 3-hydroxypropionic acid, comprising:

(a) subjecting an aqueous solution comprising a salt of 3-hydroxypropionic acid to concentrating electrodialysis to concentrate the salt of 3-hydroxypropionic acid in the aqueous solution; and

(b) subjecting the resulting concentrate to bipolar membrane electrodialysis to convert the salt of 3-hydroxypropionic acid into the free acid of 3-hydroxypropionic acid.

The present invention also relates to processes for separating and recovering a salt of 3-hydroxypropionic acid, comprising: subjecting an aqueous solution comprising a salt of 3-hydroxypropionic acid to concentrating electrodialysis to concentrate the salt of 3-hydroxypropionic acid in the aqueous solution.

The present invention also relates to processes for separating and recovering 3-hydroxypropionic acid, comprising: subjecting an aqueous solution comprising a salt of 3-hydroxypropionic acid to bipolar membrane electrodialysis to convert the salt of 3-hydroxypropionic acid into the free acid of 3-hydroxypropionic acid.

### BRIEF DESCRIPTION OF THE FIGURES

FIG. 1 shows the conductivity within the diluate tank during concentrating electrodialysis.

FIG. 2 shows the conductivity within the brine tank during concentrating electrodialysis.

FIG. 3 shows the conductance of various known concentrations of sodium 3-hydroxypropionate solutions.

FIG. 4 shows the drop in pH within the acid tank during conversion of a solution of sodium 3-hydroxypropionate (25% w/w, 4.4 kg, 60.7 mS/cm, pH 6.87) in water to the free acid of 3-hydroxypropionic acid by bipolar membrane electrodialysis using a EUR2B pilot scale electrodialysis unit equipped with a EUR2B-7Bip stack, a solution of sodium 3-hydroxypropionate charged to the acid tank, a solution of sodium hydroxide (4 kg, 0.1 M) charged to the electrode rinse tank, and a solution of sodium hydroxide (4 kg, 0.5 M) charged to the base tank.

FIG. 5 shows the drop in conductivity within the acid tank during conversion of an aqueous solution of sodium 3-hydroxypropionate (25% w/w, 4.4 kg, 60.7 mS/cm, pH 6.87) in water to the free acid of 3-hydroxypropionic acid by bipolar membrane electrodialysis using a EUR2B pilot scale electrodialysis unit equipped with a EUR2B-7Bip stack, a solution of sodium 3-hydroxypropionate charged to the acid tank, a solution of sodium hydroxide (4 kg, 0.1 M) charged to the electrode rinse tank, and a solution of sodium hydroxide (4 kg, 0.5 M) charged to the base tank.

FIG. 6 shows the increase in conductivity within the base tank during conversion of a solution of sodium 3-hydroxypropionate (25% w/w, 4.4 kg, 60.7 mS/cm, pH 6.87) in water to the free acid of 3-hydroxypropionic acid by bipolar membrane electrodialysis using a EUR2B pilot scale electrodialysis unit equipped with a EUR2B-7Bip stack, a solution of sodium 3-hydroxypropionate charged to the acid tank, a solution of sodium hydroxide (4 kg, 0.1 M) charged to the electrode rinse tank, and a solution of sodium hydroxide (4 kg, 0.5 M) charged to the base tank.

### DETAILED DESCRIPTION OF THE INVENTION

The present invention relates to processes for separating and recovering 3-hydroxypropionic acid, comprising: (a) subjecting an aqueous solution comprising a salt of 3-hydroxypropionic acid to concentrating electrodialysis to concentrate the salt of 3-hydroxypropionic acid in the aqueous solution; and (b) subjecting the resulting concentrate to bipolar membrane electrodialysis to convert the salt of 3-hydroxypropionic acid into the free acid of 3-hydroxypropionic acid.

A process of the present invention is high yielding, allows for separation of neutral components (e.g., glucose) from the salt of 3-hydroxypropionic acid, has no waste effluent like the current gypsum process, and allows for the sodium hydroxide produced in the process to be recycled back to a fermentation for pH control. Additionally, the process avoids the excess calcium sulfate byproduct mentioned above and can remove substantial amounts of color that sometimes occurs during fermentation, making the process a convenient method for simultaneous decolorizing treatment.

The present invention also relates to processes for separating and recovering a salt of 3-hydroxypropionic acid, comprising: subjecting an aqueous solution comprising a salt of 3-hydroxypropionic acid to concentrating electrodialysis to concentrate the salt of 3-hydroxypropionic acid in the aqueous solution.

The present invention also relates to processes for separating and recovering 3-hydroxypropionic acid, comprising: subjecting an aqueous solution comprising a salt of 3-hydroxypropionic acid to bipolar membrane electrodialysis to convert the salt of 3-hydroxypropionic acid into the free acid of 3-hydroxypropionic acid.

Reference to “about” a value or parameter herein includes aspects that are directed to that value or parameter per se. For example, description referring to “about X” includes the aspect “X”.

As used herein and in the appended claims, the singular forms “a,” “or,” and “the” include plural referents unless the context clearly dictates otherwise. It is understood that the aspects of the invention described herein include “consisting” and/or “consisting essentially of” aspects.

Unless defined otherwise or clearly indicated by context, all technical and scientific terms used herein have the same meaning as commonly understood by one of ordinary skill in the art to which this invention belongs.

### Salt of 3-Hydroxypropionic Acid

The salt of 3-hydroxypropionic acid can be any salt suitable for the processes of the present invention. A salt of 3-hydroxypropionic acid consists of the conjugate base of 3-hydroxypropionic acid and a cation. The cation can be, e.g., any monovalent or divalent cation that can be used as the counter ion to 3-hydroxypropionate during electrodialysis. A monovalent cation may be preferred because it may possess better ion mobility across an ion exchange membrane during electrodialysis. A divalent cation can be used but may be more prone to membrane fouling. In one aspect, the cation of the salt of 3-hydroxypropionic acid is an alkali metal (e.g., lithium, sodium, potassium). In one aspect, the cation of the salt of 3-hydroxypropionic acid is sodium. In another aspect, the cation of the salt of 3-hydroxypropionic acid is potassium. In another aspect, the cation of the salt of 3-hydroxypropionic acid is lithium. In another aspect, the cation of the salt of 3-hydroxypropionic acid is an alkali earth metal (e.g., magnesium, calcium). In one aspect, the cation of the salt of 3-hydroxypropionic acid is magnesium. In another aspect, the cation of the salt of 3-hydroxypropionic acid is calcium. In another aspect, the cation of the salt of 3-hydroxypropionic acid is an organic cation. In another aspect, the cation of the salt of 3-hydroxypropionic acid is polyatomic (e.g., ammonium). In one aspect, the salt of 3-hydroxypropionic is part of an aqueous composition comprising any two or more 3-hydroxypropionic salts (e.g., any two or more 3-hydroxypropionic salts mentioned herein, such as sodium and potassium). In another aspect, the pH of a fermentation is controlled with one base yielding only one salt of 3-hydroxypropionic acid. The base can be, for example, sodium hydroxide, potassium hydroxide, or ammonium hydroxide.

The aqueous solution comprising the salt of 3-hydroxypropionic acid can be any aqueous solution. In one aspect, the aqueous solution is a whole fermentation broth. In another aspect, the aqueous solution is a cell-free fermentation broth. The cell-free fermentation broth is a filtered solution with the majority of cellular debris and particulate matter removed (e.g., greater than 50%, greater than 75%, greater than 85%, greater than 90%, greater than 95%, or greater than 98% of the cellular debris and particulate matter removed).

Various fermentation methods known in the art can be used to produce 3-hydroxypropionic acid employing a microorganism (See, for example, WO 2002/042418; WO 2003/062173, WO 2007/042494, Straathof et al., 2005, Appl. Microbiol. Biotechnol. 67:727-734; WO 2002/042418; and WO 2003/062173). The microorganism may be any microorganism, e.g., a prokaryote or a eukaryote, and/or any cell (e.g., any yeast cell) capable of the recombinant production of 3-hydroxypropionic acid as described below.

The microorganism may be any gram-positive or gram-negative bacterium. Gram-positive bacteria include, but not limited to, Bacillus, Clostridium, Enterococcus, Geobacillus, Lactobacillus, Lactococcus, Oceanobacillus, Staphylococcus, Streptococcus, and Streptomyces. Gram-negative bacteria include, but not limited to, Campylobacter, E. coli, Flavobacterium, Fusobacterium, Helicobacter, Ilyobacter, Neisseria, Pseudomonas, Salmonella, and Ureaplasma.

The microorganism may be any Bacillus cell including, but not limited to, Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, and Bacillus thuringiensis cells. The bacterial microorganism may also be any Streptococcus cell including, but not limited to, Streptococcus equisimilis, Streptococcus pyogenes, Streptococcus uberis, and Streptococcus equi subsp. Zooepidemicus cells. The bacterial microorganism may also be any Streptomyces cell including, but not limited to, Streptomyces achromogenes, Streptomyces avermitilis, Streptomyces coelicolor, Streptomyces griseus, and Streptomyces lividans cells.

The microorganism may also be a eukaryote, such as a mammalian, insect, plant, or fungal cell.

In one aspect, the microorganism is a fungal cell. “Fungi” as used herein includes the phyla Ascomycota, Basidiomycota, Chytridiomycota, and Zygomycota (as defined by Hawksworth et al., In, Ainsworth and Bisby's Dictionary of The Fungi, 8th edition, 1995, CAB International, University Press, Cambridge, UK) as well as the Oomycota (as cited in Hawksworth et al., 1995, supra, page 171) and all mitosporic fungi (Hawksworth et al., 1995, supra).

In one aspect, the microorganism is a yeast cell. “Yeast” as used herein includes ascosporogenous yeast (Endomycetales), basidiosporogenous yeast, and yeast belonging to the Fungi Imperfecti (Blastomycetes). Since the classification of yeast may change in the future, for the purposes of this invention, yeast shall be defined as described in Biology and Activities of Yeast (Skinner, F. A., Passmore, S. M., and Davenport, R. R., eds, Soc. App. Bacteriol. Symposium Series No. 9, 1980).

The microorganism may be a Candida, Hansenula, Kluyveromyces, Pichia, Saccharomyces, Schizosaccharomyces, or Yarrowia cell such as a Kluyveromyces lactis, Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis, or Yarrowia lipolytica cell.

The microorganism may be a filamentous fungal cell. “Filamentous fungi” include all filamentous forms of the subdivision Eumycota and Oomycota (as defined by Hawksworth et al., 1995, supra). The filamentous fungi are generally characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

The filamentous fungi may be an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell. For example, the filamentous fungi may be an Aspergillus aculeatus, Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Thielavia terrestris, Trametes villosa, Trametes versicolor, Trichoderma harzianum, Trichoderma koningii, Trichoderma longibrachiatum, Trichoderma reesei, or Trichoderma viride cell.

In one aspect, the microorganism is a bacterial or yeast strain that produces 3-hydroxypropionic acid. In one aspect, the bacterial strain is an E. coli strain that produces 3-hydroxypropionic acid. In a preferred aspect, the microorganism is a metabolically engineered microorganism. In one aspect, the microorganism is a metabolically engineered E. coli strain. In another aspect, the microorganism is a metabolically engineered yeast strain. Typically, 3-hydroxypropionic acid is produced by culturing the microorganism in a culture medium such that 3-hydroxypropionic acid is produced. In general, the culture media and/or culture conditions can be such that the microorganism grows to an adequate density and produces 3-hydroxypropionic acid efficiently.

For large-scale production processes, any method can be used such as those described elsewhere (Manual of Industrial Microbiology and Biotechnology, 2^{nd} Edition, Editors: A. L. Demain and J. E. Davies, ASM Press; and Principles of Fermentation Technology, P. F. Stanbury and A. Whitaker, Pergamon). Briefly, a large tank (e.g., a 400 liters, 800 liters, 2000 liters, or more fermentation tank) containing appropriate culture medium with, for example, glucose as a carbon source is inoculated with a particular microorganism. After inoculation, the microorganism is incubated to allow biomass to be produced. Once a desired biomass is reached, the broth containing the microorganism can be transferred to a second tank. This second tank can be any size. For example, the second tank can be larger, smaller, or the same size as the first tank. Typically, the second tank is larger than the first such that additional culture medium can be added to the broth from the first tank. In addition, the culture medium within this second tank can be the same as, or different from, that used in the first tank. For example, the first tank can contain medium with xylose, while the second tank contains medium with glucose.

Production of the 3-hydroxypropionic acid can be performed by batch fermentation, fed-batch fermentation, or continuous fermentation. In certain aspects, it is desirable to perform the fermentation under reduced oxygen or anaerobic conditions for certain microorganisms. In other aspects, 3-hydroxypropionic acid production can be performed with oxygen; and, optionally with the use of an air-lift or equivalent fermentor.

Fermentation parameters are dependent on the microorganism used for production of the 3-hydroxypropionic acid. Cultivation of the microorganism is preferably performed under aerobic or anaerobic conditions for about 0.5 to about 240 hours. During cultivation, temperature is preferably controlled at about 25° C. to about 45° C., and pH is preferably controlled at about 5 to about 8. The pH can be adjusted using common acids or bases such as acetic acid or sodium hydroxide. In a preferred aspect, the pH of the fermentation is adjusted using one base so that the 3-hydroxypropionic acid is in the form of only one salt of 3-hydroxypropionic acid. The pH of the fermentation should be sufficiently high enough to allow growth of the microorganism and 3-hydroxypropionic acid production by the microorganism.

Growth medium may be minimal/defined or complete/complex. Fermentable carbon sources can include hexose and pentose sugars (e.g., ribose, arabinose, xylose, and lyxose), starch, cellulose, xylan, oligosaccharides, and combinations thereof. Examples of carbohydrates that cells are capable of metabolizing to pyruvate include sugars such as dextrose, triglycerides, and fatty acids. One form of growth media that can be used includes modified Luria-Bertani (LB) broth (with 10 g Difco tryptone, 5 g Difco yeast extract, and 5 g sodium chloride per liter) as described by Miller, 1992, A Short Course in Bacterial Genetics: A Laboratory Manual and Handbook for Escherichia coli and Related Bacteria, Cold Spring Harbor Press. In other aspects, cultures of a microorganism, e.g., an E. coli strain, can be grown in NBS mineral salts medium (Causey et al., 2004, Proc. Natl. Acad. Sci. USA 101: 2235-2240) and supplemented with 2% to 20% sugar (w/v) or either 5% or 10% sugar (glucose or sucrose). 4-Morpholinopropanesulfonic acid (0.1 M, pH 7.1) can be added to both liquid and solid media (filter-sterilized) when needed for pH control (and is optionally included in medium used for 10-liter fermentations). Minimal medium can also be prepared by using succinate (1 g/liter) as a sole source of carbon (nonfermentable substrate) and can be added as a supplement to glucose-minimal medium when needed. In certain aspects, antibiotics can be included as needed.

The selection and incorporation of any of the above fermentation methods is dependent on the microorganism used.

In one aspect, the 3-hydroxypropionic acid is produced via pyruvate through lactate by engineering the metabolic steps leading from pyruvate to 3-hydroxypropionic acid to allow for unimpeded flow of intermediates from pyruvate to 3-hydroxypropionic acid.

In another aspect, the 3-hydroxypropionic acid is produced via pyruvate through acetyl-CoA by engineering the metabolic steps leading from pyruvate to 3-hydroxypropionic acid to allow for unimpeded flow of intermediates from pyruvate to 3-hydroxypropionic acid.

In another aspect, the 3-hydroxypropionic acid is produced from propionate through propionyl-CoA and acrylyl-CoA by engineering the metabolic steps leading from pyruvate to 3-hydroxypropionic acid to allow for unimpeded flow of intermediates from propionate to 3-hydroxypropionic acid.

In another aspect, the 3-hydroxypropionic acid is produced via phosphoenolpyruvate or pyruvate through beta-alanine and acrylyl-CoA by engineering the metabolic steps leading from phosphoenolpyruvate or pyruvate to 3-hydroxypropionic acid to allow for unimpeded flow of intermediates from phosphoenolpyruvate or pyruvate to 3-hydroxypropionic acid.

In another aspect, the 3-hydroxypropionic acid is produced via phosphoenolpyruvate or pyruvate through beta-alanine and malonate semialdehyde by engineering the metabolic steps leading from phosphoenolpyruvate or pyruvate to 3-hydroxypropionic acid to allow for unimpeded flow of intermediates from phosphoenolpyruvate or pyruvate to 3-hydroxypropionic acid.

In another aspect, the 3-hydroxypropionic acid is produced wherein lactate is contacted with a CoA transferase or a CoA synthetase such that lactyl-CoA is formed, then contacting the lactyl-CoA with a lactyl-CoA dehydratase to form acrylyl-CoA, then contacting the acrylyl-CoA with a 3-hydroxypropionyl-CoA dehydratase to form 3-hydroxypropionic acid-CoA, and then contacting the 3-hydroxypropionic acid-CoA with the CoA transferase or the CoA synthetase to form 3-hydroxypropionic acid or with a 3-hydroxypropionyl-CoA hydrolase or a 3-hydroxyisobutryl-CoA hydrolase to form 3-hydroxypropionic acid.

The 3-hydroxypropionic acid is preferably produced by a microorganism, e.g., yeast or E. coli, at a concentration of preferably at least about 20 g, more preferably at least about 40 g, more preferably at least about 60 g, more preferably at least about 80 g, even more preferably at least about 100 g, most preferably at least about 120 g, and even most preferably at least about 140 g per liter.

The aqueous solution comprising a salt of 3-hydroxypropionic acid may also be obtained from methods other than fermentation, such as chemical processes. See, for example, WO 2005/003074, which discloses production of the free acid of 3-hydroxypropionic from the hydration of acrylic acid; where the salt is easily produced from the hydration of acrylic acid followed by the addition of a base.

When determining the concentration of the 3-hydroxypropionic acid, any method known in the art can be used. See, for example, Applied Environmental Microbiology 59: 4261-4265 (1993) and Sullivan and Clarke, 1955, J. Assoc. Offic. Agr. Chemists, 38: 514-518.

Once the 3-hydroxypropionic acid is produced, common separation techniques can be used to remove the biomass from the broth, such as filtration or centrifugation. If the 3-hydroxypropionic acid is secreted into the nutrient medium, the 3-hydroxypropionic acid can be recovered directly from the medium. If the 3-hydroxypropionic acid is not secreted into the medium, the 3-hydroxypropionic acid can be recovered from cell lysates.

### Electrodialysis

Electrodialysis is defined herein as a process used to transport ions from one solution through ion-exchange membranes to another solution under the influence of an applied electric potential difference. As such, electrodialysis can separate, concentrate, and/or purify a charged component of interest, e.g., 3-hydroxypropionate, from aqueous solutions, such as fermentation broth.

In the processes of the present invention, an aqueous solution comprising a salt of 3-hydroxypropionic acid is subjected to concentrating electrodialysis to concentrate the salt of 3-hydroxypropionic acid in the aqueous solution. In another aspect, the aqueous solution comprising a salt of 3-hydroxypropionic acid is subjected to bipolar membrane electrodialysis to convert the salt of 3-hydroxypropionic acid into the free acid of 3-hydroxypropionic acid. In another aspect, the aqueous solution comprising a salt of 3-hydroxypropionic acid is subjected to concentrating electrodialysis to concentrate the salt of 3-hydroxypropionic acid followed by bipolar membrane electrodialysis to convert the salt of 3-hydroxypropionic acid into the free acid of 3-hydroxypropionic acid.

In one aspect, sodium hydroxide produced during the processes of the present invention is recycled to a fermentation for pH control. The recycling may be conducted using methods known in the art.

Prior to electrodialysis, the pH of the aqueous solution comprising the salt of 3-hydroxypropionic acid is preferably at least 6, more preferably at least 6.5, even more preferably at least 7, most preferably at least 7.5, and even most preferably at least 8. The pH can be adjusted using common acids or bases such as acetic acid or sodium hydroxide. In a preferred aspect, the pH of the aqueous solution is adjusted using one base yielding only one salt of 3-hydroxypropionic acid. Such a base can be, for example, sodium hydroxide, potassium hydroxide, or ammonium hydroxide.

Prior to electrodialysis, the aqueous solution can be further submitted to other pretreatments such as ion exchange to remove trace amounts of multivalent cations such as calcium, iron, or magnesium to prevent membrane fouling and/or to decolorization using agents such as decolorizing carbon.

### Concentrating Electrodialysis

In the processes of the present invention, the first step may involve concentrating electrodialysis, which is based on the property of ion-exchange membranes. The membranes used in concentrating electrodialysis are selectively charged in order to separate ions (i.e., cations and anions). If the membrane is positively charged, only anions will be allowed through. Such a membrane is called an anion-exchange membrane. Similarly, a negatively charged membrane is called a cation-exchange membrane. This membrane property is known as permselectivity. Any anion-exchange membrane or cation-exchange membrane suitable for concentrating electrodialysis can be used in the processes of the present invention. Such membranes are commercially available from Astom Corp. (Tokyo, Japan), e.g., Neosepta membranes, Tokuyama Co., Ltd. (Tokyo, Japan), Ameridia (Somerset, N.J., USA), Eurodia Industrie S.A. (Wissous, France), CelTech, Inc. (Fayetteville, N.C., USA), Eden Purification Systems (North Haven, Conn., USA), Ion Power, Inc. (Bear, Del., USA), Minntech Corporation (Minneapolis, Minn., USA), and GE Water & Process Technologies (Trevose, Pa., USA).

The concentrating electrodialysis can be performed with any available concentrating electrodialysis unit. Such units are available commercially from suppliers such as Eet Corporation (Harriman, Tenn., USA), Mega A.S. (Drahobejlova, Praha, Czech Republic), or Ameridia (Somerset, N.J., USA), a division of Eurodia Insdustrie S.A. (Wissous, France). By way of example, a concentrating electrodialysis unit from Ameridia is described below.

The concentrating electrodialysis is preferably performed using a configuration known as an electrodialysis cell. The cell consists of a feed (diluate) compartment and a concentrate (brine) compartment formed by an anion exchange membrane and a cation exchange membrane placed between two electrodes. The electrodialysis process preferably employs multiple electrodialysis cells arranged into a configuration known as an electrodialysis stack, with alternating anion and cation exchange membranes forming the multiple electrodialysis cells. The number of cells can range from a few, e.g., ten cells, to hundreds of cells in one stack. A clamping system keeps the assembly together under a uniform closing pressure. The driving force is a direct current between anodes (positive electrodes) and cathodes (negative electrodes) housed at the two ends of the stack.

Several parameters determine the optimum range of applicability of the concentrating electrodialysis in the present invention. The parameters include current density, cell voltage, current efficiency, diluate concentration, and concentrate concentration.

The current density is the driving force of the process as it determines the quantity of equivalent grams of product that are transported across the membranes. Running at a high current density reduces the required surface of electrodialysis cells. However, the current density has to be balanced with a disproportionate cell voltage increase resulting in higher power consumption. The term “limiting current” is defined herein as the maximum allowed current density to avoid a steep cell voltage increase. The limiting current is known in the art to depend on parameters such as stack design, solution concentrations, temperature, etc.

Current efficiency also determines the surface of membranes required for the processes of the present invention. The term “current efficiency” is defined herein as the efficiency of an electrochemical process. The amount of material obtained during electrolysis is generally less than that expected due to loss of energy during its flow through the system and due to other side-reactions taking place during electrolysis. The current efficiency takes into consideration all the parasitic phenomena occurring in the stack, such as the non-perfect permselectivity of membranes or physical leakage (leading to impurities in the products), that can be reduced by optimized stack design and membrane selection.

Another important parameter is the concentrations (conductivities) of the two streams. The ratio of conductivities affects the current efficiency, limiting the maximum concentration for the concentrate (brine) stream. In general, the minimum diluate concentration is limited by conductivity considerations due to the ohmic resistance of the diluate cells and the low limiting currents at low conductivities. The minimum conductivity that can be considered is approximately 0.5 mS/cm. The minimum starting concentration of the salt of 3-hydroxypropionic acid for performing concentrating electrodialysis is one whose conductivity is preferably at least 10 mS/cm (20 g/liter), more preferably at least 20 mS/cm (40 g/liter), even more preferably at least 40 mS/cm (80 g/liter), and most preferably at least 60 mS/cm (120 g/liter).

Membrane fouling and stack plugging can result from impurities in the aqueous solution, either soluble or insoluble, such as organic matter, colloidal substances, microorganisms (e.g., yeast or bacteria), insoluble salts, etc. In one aspect, the aqueous solution is preferably pretreated to remove impurities and particulate matter. Any pretreatment method known in the art can be used. For example, typical methods include, but are not limited to, centrifugation, microfiltration, nanofiltration, and ion exchange. However, when membranes become fouled with such impurities, they can be cleaned using standard methods known in the art such as the use of current reversal or dilute acid, caustic, and/or enzyme solutions.

Temperature and pH can also influence the effectiveness of the electrodialysis processes of the present invention. The maximum temperature range in concentrating electrodialysis stacks is typically about 10° C. to about 40° C. The maximum pH range in concentrating electrodialysis stacks is typically about 4 to about 8. However, the optimal pH range is dependent not only on the type of membrane used, but also on the pKa of 3-hydroxypropionic acid.

The concentrating electrodialysis may be conducted at a temperature in the range of about 10° C. to about 40° C., or about 15° C. to about 35° C., or about 20° C. to about 30° C.

In the processes of the present invention, the concentrating electrodialysis may be conducted at a pH that is at least about 6, at least about 6.5, at least about 7, at least about 7.5, or at least about 8.

In the electrodialysis process described herein, the aqueous solution comprising the salt of 3-hydroxypropionic acid is fed into the electrodialysis stack through the diluate compartment. When the solution arrives in the active area of the cells, the direct current (DC) voltage causes the positively charged cations to migrate toward the cathode and the negatively charged anions to migrate toward the anode. When the ions reach an ion exchange membrane, the membrane properties determine whether the ions are rejected or allowed to pass through. The ions that can pass through the membranes are retained in the next compartment since the next membrane in its path will be of the opposite charge. Therefore, there are compartments from where the ions are removed and some compartments where they are concentrated. If the solutions are circulated rapidly through the stack, a diluate and a concentrate stream are obtained. The product can be the desalted stream, the concentrate stream, or both.

The low amount of water transported with the salt across the membranes (known as “concentration transport”) enables the brine stream to have a higher concentration than the feed stream. Therefore, it is possible not only to remove salts from a solution, but also to concentrate a solution by electrodialysis. The present invention utilizes this concentrating electrodialysis to concentrate the aqueous solution of the salt of 3-hydroxypropionic acid.

The maximum concentration of the salt of 3-hydroxypropionic acid obtained by concentrating electrodialysis is about 100 g/liter, about 125 g/liter, about 150 g/liter, about 175 g/liter, about 200 g/liter, about 250 g/liter, or about 300 g/liter.

### Bipolar Membrane Electrodialysis

In the processes of the present invention, the second step may involve contacting the resulting concentrate from the concentrating electrodialysis to bipolar membrane electrodialysis to convert the salt of 3-hydroxypropionic acid into the free acid of 3-hydroxypropionic acid. However, in the processes of the present invention, it is recognized that the concentrating step may be omitted (e.g., in cases where the concentration of 3-hydroxypropionic acid is sufficiently high).

The bipolar membrane electrodialysis can be performed with any available bipolar membrane electrodialysis unit. Such units are available commercially from suppliers such as The Electrosynthesis Company, Inc. (Lancaster, N.Y., USA), FuMA-Tech GmbH (Vaihingen, Germany), Solvay SA (Brussels, Belgium), Tokuyama Co., Ltd. (Tokyo, Japan), Graver Water Co. (USA), Tianwei, Membrane Technology Co. Ltd. (Shandong, China), Ameridia (Somerset, N.J., USA), a division of Eurodia Insdustrie S.A. (Wissous, France). By way of example, a bipolar membrane electrodialysis unit from Ameridia is described below.

The bipolar membrane electrodialysis is also preferably performed using an electrodialysis cell. Bipolar membrane electrodialysis is defined herein as a process that allows efficient conversion of aqueous salt solutions into acids and bases without chemical addition. As such, bipolar membrane electrodialysis is an electrodialysis process where bipolar membranes carry out the dissociation of water, also called water splitting, in the presence of an electric field. In addition, this process allows one to directly acidify or basify process streams without adding chemicals, avoiding by-product or waste streams and costly downstream purification steps.

Under the driving force of an electrical field, a bipolar membrane dissociates water into hydrogen (H+) and hydroxyl (OH−) ions. A bipolar membrane is formed of an anion- and a cation-exchange layer that are bound together, and a very thin interface where the water diffuses from the outside aqueous salt solutions. With the anion-exchange side facing the anode and the cation-exchange side facing the cathode, the hydroxyl anions will be transported across the anion-exchange layer and the hydrogen cations across the cation-exchange layer. A bipolar membrane allows the generation and concentration of hydroxyl and hydrogen ions at its surface. These ions can be used in an electrodialysis stack to combine with the cations and anions of the salt to produce acids and bases. In the present invention, bipolar membrane electrodialysis is used to convert a solution of the salt of 3-hydroxypropionic acid to the free acid of 3-hydroxypropionic acid.

Any bipolar membrane suitable for bipolar membrane electrodialysis can be used in the processes of the present invention. Such membranes are commercially available from Astom Corp. (Tokyo, Japan), e.g., Neosepta membranes, Tokuyama Co., Ltd. (Tokyo, Japan), Ameridia (Somerset, N.J., USA), Eurodia Industrie S.A. (Wissous, France), CelTech, Inc. (Fayetteville, N.C., USA), Eden Purification Systems (North Haven, Conn., USA), Ion Power, Inc. (Bear, Del., USA), Minntech Corporation (Minneapolis, Minn., USA), and GE Water & Process Technologies (Trevose, Pa., USA)

The same parameters for performing concentrating electrodialysis also apply to the bipolar membrane electrodialysis processes of the present invention; i.e., current density, cell voltage, current efficiency, diluate concentration, concentrate concentration, pH, temperature, etc.

The minimum starting concentration of the salt of 3-hydroxypropionic acid for performing bipolar membrane electrodialysis is one whose conductivity is preferably at least 10 mS/cm or 20 g/liter.

The bipolar membrane electrodialysis is conducted at a temperature in the range of about 10° C. to about 40° C., about 15° C. to about 35° C., or about 20° C. to about 30° C.

The bipolar membrane electrodialysis may be conducted at a pH that is at least about 6, at least about 6.5, at least about 7, at least 7.5 about, or at least about 8.

The maximum concentration of the free acid of 3-hydroxypropionic acid obtained by bipolar membrane electrodialysis is preferably about 300 g/liter.

In the processes of the present invention, the conversion of the salt of 3-hydroxypropionic acid to the free acid of 3-hydroxypropionic acid is at least 90%, at least 92%, at least 95%, or at least 98%.

It is understood herein that the concentrating electrodialysis unit and the bipolar membrane electrodialysis unit can be integrated into the same apparatus. Different bipolar membrane electrodialysis configurations are possible and described by manufacturers. A three-compartment cell is obtained by adding the bipolar membrane in a concentrating electrodialysis cell. In such a case, the bipolar membrane is flanked on either side by the anion- and cation-exchange membranes described above to form three compartments: acid between the bipolar and the anion-exchange membranes, base between the bipolar and the cation-exchange membranes, and salt between the cation- and anion-exchange membranes. A two-compartment cell can be obtained by adding bipolar and cation-exchange membranes or by adding bipolar and anion-exchange membranes. In the present invention, a two compartment cell with alternating cation-exchange membranes and bipolar membranes is utilized.

### Recovery

While the salt of 3-hydroxypropionic acid or the free acid of 3-hydroxypropionic acid obtained according to the processes of the present invention may be used as is, the processes may further comprise recovering the salt of 3-hydroxypropionic acid or the free acid of 3-hydroxypropionic acid using any method known in the art. Such non-limiting methods may include precipitation e.g., calcium sulfate, crystallization, and extraction.

### Uses of 3-Hydroxypropionic Acid

The 3-hydroxypropionic acid obtained according to the processes of the present invention can be used, e.g., to obtain other organic compounds such as 1,3-propanediol, acrylic acid, polymerized acrylate, esters of acrylate, esters of 3-hydroxypropionic acid, and polymerized 3-hydroxypropionic acid. For example, 3-hydroxypropionic acid can be modified into a derivative such as polymerized 3-hydroxypropionic acid or an ester of 3-hydroxypropionic acid. Likewise, a chemical process can be used to produce a particular compound that is converted into another organic compound (e.g., 1,3-propanediol, acrylic acid, polymerized acrylate, esters of acrylate, esters of 3-hydroxypropionic acid, and polymerized 3-hydroxypropionic acid) using a cell, substantially pure polypeptide, and/or cell-free extract. For example, a chemical process can be used to produce acrylyl-CoA, while a microorganism can be used convert acrylyl-CoA into 3-hydroxypropionic acid (see U.S. Pat. No. 7,186,541 and “Top Value Added Chemicals from Biomass”, Pacific Northwest National Laboratory and National Renewable Energy Laboratory, T. Werpy and G. Petersen, August 2004).

The present invention is further described by the following examples that should not be construed as limiting the scope of the invention.

### EXAMPLES

### Electrodialysis

A EUR2B pilot scale electrodialysis unit from Ameridia (Somerset, N.J., USA), a Division of Eurodia Industries S.A. (Wissous, France), was used in the Examples below. The unit was supplied with two electrodialysis stacks, one for concentrating electrodialysis (EUR2B-10 stack) and the other (EUR2B-7Bip) for bipolar membrane electrodialysis.

The EUR2B-10 stack consists of 10 cells with alternating anion- and cation-exchange membranes (NEOSEPTA® ion exchange membranes (Astom Corp., Tokyo, Japan). The area of each membrane was 2 dm². The EUR2B-10 stack was used for concentrating a sodium 3-hydroxypropionate solution.

The EUR2B-7Bip stack consists of 7 cells with alternating cationic and bipolar membranes (NEOSEPTA® BP-1E membranes (Astom Corp., Tokyo, Japan). The area of each membrane was 2 dm². The EUR2B-7Bip stack was used for converting a solution of sodium 3-hydroxypropionate to its free acid.

### Example 1

### Concentration of a Sodium 3-Hydroxypropionate Solution Using Concentrating Electrodialysis

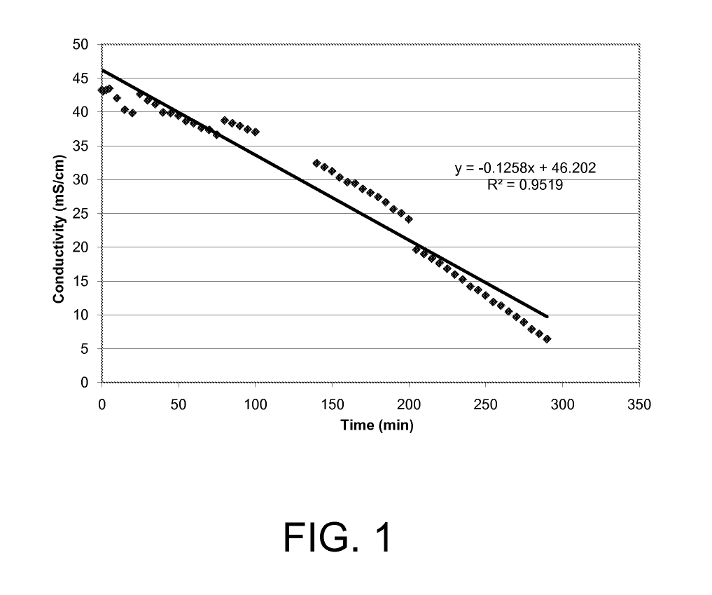

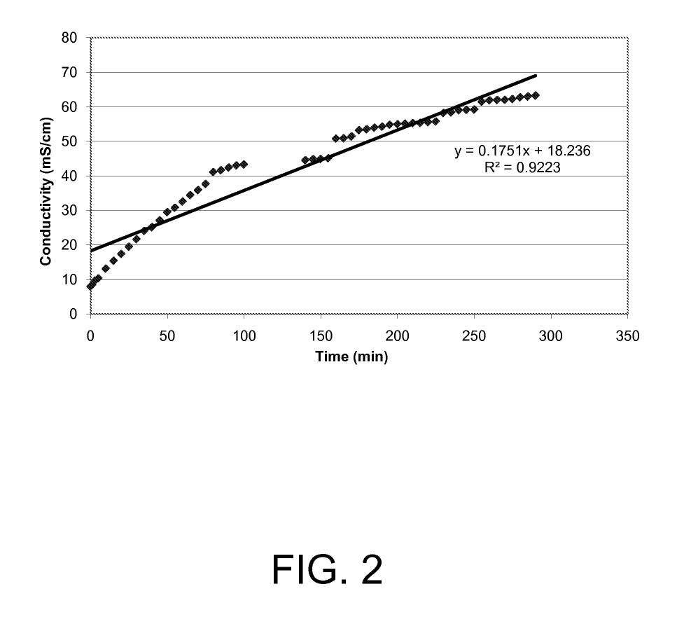

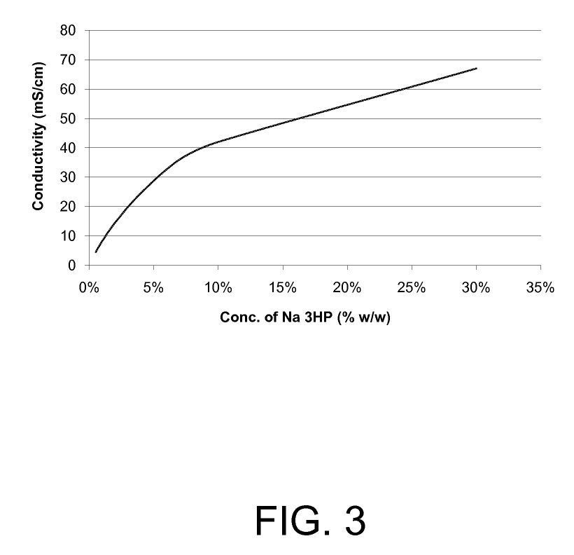

A solution of sodium 3-hydroxypropionate (10% w/w, 8.0 kg) in water was concentrated by concentrating electrodialysis using a EUR2B pilot scale electrodialysis unit equipped with a EUR2B-10 stack as described above. The solution of sodium 3-hydroxypropionate with a conductance of 43 mS/cm and a pH of 6.7 was charged to the diluate tank. A solution of potassium nitrate (20 mS/cm, 4.0 kg) was charged to the electrode rinse tank. A dilute solution of sodium 3-hydroxypropionate (10 mS/cm) was charged to the brine tank. The solutions described above were circulated through the EUR2B-10 stack at a flow rate of about 3.5 liter per minute (gpm) using a DC power supply set at 14 volts. During the run, the conductivity within the diluate tank dropped, while the conductivity within the brine tank rose, as shown in FIGS. 1 and 2, respectively. After 290 minutes, the conductivity change within the diluate and brine tanks remained stable and the run was ended. The final conductance within the brine tank was 63 mS/cm, which indicated a final sodium 3-hydroxypropionate concentration of about 30% (w/w) as shown in FIG. 3. Before and during the run, samples were taken to verify sample purity and concentration by HPLC using an Agilent 1100 (Santa Clara, Calif., USA) equipped with a Charged Aerosol Detection (CAD; ESA BioSciences, Chelmsford, Mass., USA). The HPLC conditions used were as follows:

HPLC Method for 3-Hydroxypropionic Acid

| | |
|---|---|
| Column | BIO-RAD ® Aminex HPX-87H; 300 × 7.8 mm |
| Column temperature | 35° C. |
| Eluent | pH 1.8 H₂SO₄ (ca. 5 mM; isochratic) |
| Injection volume | 10 μl |
| Flow rate | 0.6 ml per min |
| CAD detection | |
| UV detection | 210 nm |
| HPLC | Agilent 1100 |
| Back pressure | 70 BAR |

The final conductance within the diluate tank was 6.4 mS/cm, which corresponded to a final diluate concentration of <1% (w/w) or a 93% yield in transfer of sodium 3-hydroxypropionate for this batch process.

### Example 2

### Separation of a Mixture of Sodium 3-Hydroxypropionate and Glucose by Concentrating Electrodialysis

A mixture of sodium 3-hydroxypropionate and glucose was separated by concentrating electrodialysis using the same procedure described in Example 1. Glucose was added at a concentration of 0.5% (w/w) to a sodium 3-hydroxypropionate solution (10% w/w, 8.0 kg) in water in the initial diluate tank. After the run corresponding to >95% transfer of the sodium 3-hydroxypropionate from the diluate tank to the brine tank, as evidenced from conductivity measurements, samples from the brine tank and the diluate tank were evaluated by HPLC as described in Example 1. The diluate tank showed that the glucose remained behind and did not migrate to the brine tank. The brine tank was completely free of glucose and showed only components of the original sodium 3-hydroxypropionate sample.

### Example 3

### Conversion of a Solution of Sodium 3-Hydroxypropionate to the Free Acid of 3-Hydroxypropionic Acid by Bipolar Membrane Electrodialysis

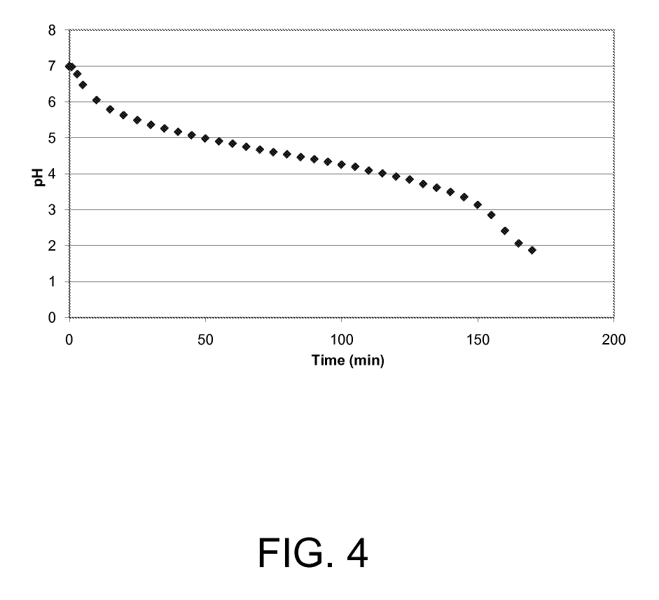

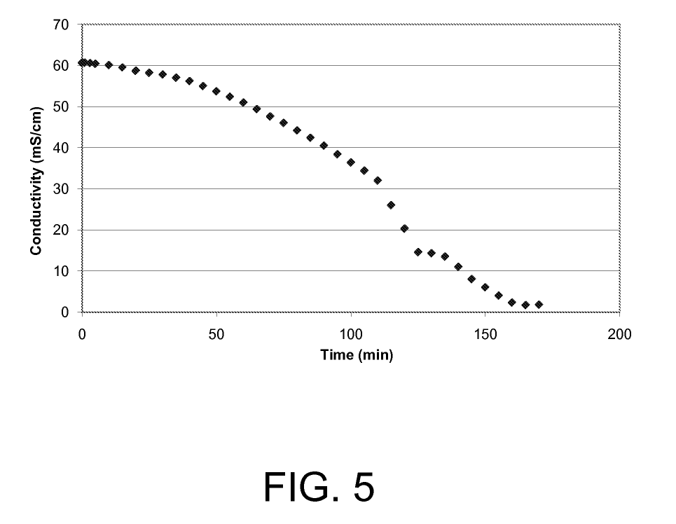

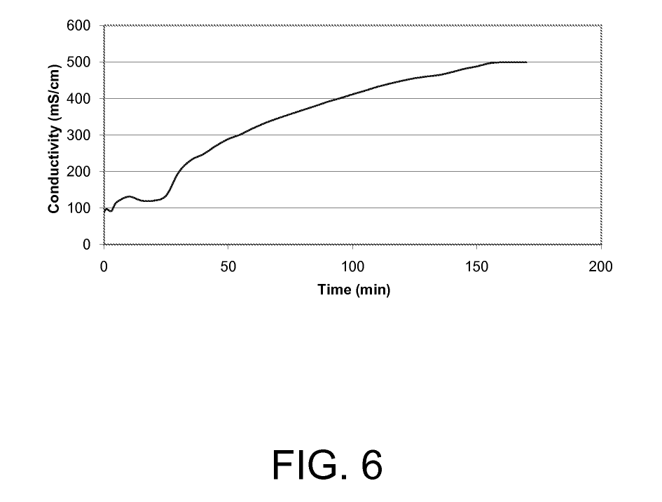

A solution of sodium 3-hydroxypropionate (25% w/w, 4.4 kg, 60.7 mS/cm, pH 6.87) in water was converted to the free acid of 3-hydroxypropionic acid by bipolar membrane electrodialysis using a EUR2B pilot scale electrodialysis unit equipped with a EUR2B-7Bip stack as described above. The solution of sodium 3-hydroxypropionate was charged to the acid tank. A solution of sodium hydroxide (4 kg, 0.1 M) was charged to the electrode rinse tank. A solution of sodium hydroxide (4 kg, 0.5 M) was charged to the base tank. The solutions were circulated through the EUR2B-7Bip stack at a flow rate of about 0.8 gpm using a DC power supply at initial settings of 20 amps and 19 volts. During the run, the pH and conductivity dropped within the acid tank as shown in FIGS. 4 and 5 respectively, while the conductivity in the base tank rose as shown in FIG. 6. The amperage was maintained at 20 amps by adjusting voltage control as needed. The run was ended when the conductivity in the acid tank dropped sufficiently low and back-migration of sodium ion to the acid tank began (170 minutes). A sample from the acid tank was submitted to atomic absorption analysis using a Perkin Elmer AAnalyst 200 (Waltham, Mass., USA) according to the manufacturer's instructions. The atomic absorption analysis indicated the concentration of sodium ion remaining in the acid tank was 1,200 ppm, which was estimated to be a migration yield of >98.5%.

The present invention may be described by the following numbered paragraphs:

[1] A process for separating and recovering 3-hydroxypropionic acid, comprising:

(a) subjecting an aqueous solution comprising a salt of 3-hydroxypropionic acid to concentrating electrodialysis to concentrate the salt of 3-hydroxypropionic acid in the aqueous solution; and

(b) subjecting the resulting concentrate to bipolar membrane electrodialysis to convert the salt of 3-hydroxypropionic acid into the free acid of 3-hydroxypropionic acid.

[2] The process of paragraph 1, which furthers comprises: (c) recovering the free acid of 3-hydroxypropionic acid.

[3] The process of paragraph 1 or 2, wherein the aqueous solution is a fermentation broth.

[4] The process of paragraph 3, wherein the fermentation broth is a cell-free fermentation broth.

[5] The process of any of paragraphs 1-4, wherein the 3-hydroxypropionic acid is produced by a microorganism at a concentration of preferably at least about 20 g, more preferably at least about 40 g, more preferably at least about 60 g, more preferably at least about 80 g, even more preferably at least about 100 g, most preferably at least about 120 g, and even most preferably at least about 140 g per liter.

[6] The process of any of paragraphs 1-5, wherein the salt of 3-hydroxypropionic acid consists of the conjugate base of 3-hydroxypropionic acid and a cation.

[7] The process of paragraph 6, wherein the cation is a monovalent or divalent cation.

[8] The process of paragraph 7, wherein the monovalent cation is sodium, potassium, or ammonium.

[9] The process of any of paragraphs 1-8, wherein the pH of the aqueous solution comprising the salt of 3-hydroxypropionic acid is preferably at least 6, more preferably at least 6.5, even more preferably at least 7, most preferably at least 7.5, and even most preferably at least 8.

[10] The process of any of paragraphs 1-9, wherein the minimum starting concentration of the salt of 3-hydroxypropionic acid in the concentrating electrodialysis is one whose conductivity is preferably at least 10 mS/cm, more preferably at least 20 mS/cm, even more preferably at least 40 mS/cm, and most more preferably at least 60 mS/cm.

[11] The process of any of paragraphs 1-10, wherein the concentrating dialysis is conducted at a temperature in the range of about 10° C. to about 40° C., more preferably about 15° C. to about 35° C., and most preferably about 20° C. to about 30° C.

[12] The process of any of paragraphs 1-11, wherein the concentrating electrodialysis is conducted at a pH that is preferably at least 6, more preferably at least 6.5, even more preferably at least 7, most preferably at least 7.5, and even most preferably at least 8.0.

[13] The process of any of paragraphs 1-12, wherein the maximum concentration of the salt of 3-hydroxypropionic acid obtained by concentrating electrodialysis is preferably about 100 g/liter, more preferably about 125 g/liter, more preferably about 150 g/liter, more preferably about 175 g/liter, more preferably about 200 g/liter, even more preferably about 250 g/liter, and most preferably about 300 g/liter.

[14] The process of any of paragraphs 1-13, wherein the minimum starting concentration of the salt of 3-hydroxypropionic acid during bipolar membrane electrodialysis is one whose conductivity is preferably at least 10 mS/cm.

[15] The process of any of paragraphs 1-14, wherein the bipolar membrane electrodialysis is conducted at a temperature in the range of preferably about 10° C. to about 40° C., more preferably about 15° C. to about 35° C., and most preferably about 20° C. to about 30° C.

[16] The process of any of paragraphs 1-15, wherein the bipolar membrane electrodialysis is conducted at a pH that is preferably at least 6, more preferably at least 6.5, even more preferably at least 7, most preferably at least 7.5, and even most preferably at least 8.

[17] The process of any of paragraphs 1-16, wherein the maximum concentration of the free acid of 3-hydroxypropionic acid obtained by bipolar membrane electrodialysis is preferably about 300 g/liter.

[18] The process of any of paragraphs 1-17, wherein the conversion of the salt of 3-hydroxypropionic acid to the free acid of 3-hydroxypropionic acid is preferably at least 90%, more preferably at least 92%, even more preferably at least 95%, and most preferably at least 98%.

[19] The process of any of paragraphs 1-18, wherein the sodium hydroxide produced is recycled to a fermentation for pH control.

[20] The process of any of paragraphs 1-19, further comprising contacting the 3-hydroxypropionic acid with a catalyst to form acrylic acid.

[21] A process for separating and recovering a salt of 3-hydroxypropionic acid, comprising: subjecting an aqueous solution comprising the salt of 3-hydroxypropionic acid to concentrating electrodialysis to concentrate the salt of 3-hydroxypropionic acid in the aqueous solution.

[22] The process of paragraph 21, which further comprises recovering the salt of 3-hydroxypropionic acid.

[23] The process of paragraph 21 or 22, wherein the aqueous solution is a fermentation broth.

[24] The process of paragraph 23, wherein the fermentation broth is a cell-free fermentation broth.

[25] The process of any of paragraphs 21-24, wherein the 3-hydroxypropionic acid is produced by a microorganism at a concentration of preferably at least about 20 g, more preferably at least about 40 g, more preferably at least about 60 g, more preferably at least about 80 g, even more preferably at least about 100 g, most preferably at least about 120 g, and even most preferably at least about 140 g per liter

[26] The process of any of paragraphs 21-25, wherein the salt of 3-hydroxypropionic acid consists of the conjugate base of 3-hydroxypropionic acid and a cation.

[27] The process of paragraph 26, wherein the cation is a monovalent or divalent cation.

[28] The process of paragraph 27, wherein the monovalent cation is sodium, potassium, or ammonium.

[29] The process of any of paragraphs 21-28, wherein the pH of the aqueous solution comprising the salt of 3-hydroxypropionic acid is preferably at least 6, more preferably at least 6.5, even more preferably at least 7, most preferably at least 7.5, and even most preferably at least 8.

[30] The process of any of paragraphs 21-29, wherein the minimum starting concentration of the salt of 3-hydroxypropionic acid in the concentrating electrodialysis is one whose conductivity is preferably at least 10 mS/cm, more preferably at least 20 mS/cm, even more preferably at least 40 mS/cm, and most more preferably at least 60 mS/cm.

[31] The process of any of paragraphs 21-30, wherein the concentrating dialysis is conducted at a temperature in the range of about 10° C. to about 40° C., more preferably about 15° C. to about 35° C., and most preferably about 20° C. to about 30° C.

[32] The process of any of paragraphs 21-31, wherein the concentrating electrodialysis is conducted at a pH that is preferably at least 6, more preferably at least 6.5, even more preferably at least 7, most preferably at least 7.5, and even most preferably at least 8.0.

[33] The process of any of paragraphs 21-32, wherein the maximum concentration of the salt of 3-hydroxypropionic acid obtained by concentrating electrodialysis is preferably about 100 g/liter, more preferably about 125 g/liter, more preferably about 150 g/liter, more preferably about 175 g/liter, more preferably about 200 g/liter, even more preferably about 250 g/liter, and most preferably about 300 g/liter.

[34] A process for separating and recovering 3-hydroxypropionic acid, comprising: subjecting an aqueous solution comprising a salt of 3-hydroxypropionic acid to bipolar membrane electrodialysis to convert the salt of 3-hydroxypropionic acid into the free acid of 3-hydroxypropionic acid.

[35] The process of paragraph 34, which further comprises recovering the free acid of 3-hydroxypropionic acid.

[36] The process of paragraph 34 or 35, wherein the salt of 3-hydroxypropionic acid consists of the conjugate base of 3-hydroxypropionic acid and a cation.

[37] The process of paragraph 36, wherein the cation is a monovalent or divalent cation.

[38] The process of paragraph 37, wherein the monovalent cation is sodium, potassium, or ammonium.

[39] The process of any of paragraphs 34-38, wherein the minimum starting concentration of the salt of 3-hydroxypropionic acid during bipolar membrane electrodialysis is one whose conductivity is preferably at least 10 mS/cm.

[40] The process of any of paragraphs 34-39, wherein the bipolar membrane electrodialysis is conducted at a temperature in the range of preferably about 10° C. to about 40° C., more preferably about 15° C. to about 35° C., and most preferably about 20° C. to about 30° C.

[41] The process of any of paragraphs 34-40, wherein the bipolar membrane electrodialysis is conducted at a pH that is preferably at least 6, more preferably at least 6.5, even more preferably at least 7, most preferably at least 7.5, and even most preferably at least 8.

[42] The process of any of paragraphs 34-41, wherein the maximum concentration of the free acid of 3-hydroxypropionic acid obtained by bipolar membrane electrodialysis is preferably about 300 g/liter.

[43] The process of any of paragraphs 34-42, wherein the conversion of the salt of 3-hydroxypropionic acid to the free acid of 3-hydroxypropionic acid is preferably at least 90%, more preferably at least 92%, even more preferably at least 95%, and most preferably at least 98%.

[44] The process of any of paragraphs 34-43, wherein sodium hydroxide produced is recycled to a fermentation for pH control.

[45] The process of any of paragraphs 34-44, further comprising contacting the 3-hydroxypropionic acid with a catalyst to form acrylic acid.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1. A process for separating and recovering 3-hydroxypropionic acid, comprising: subjecting an aqueous solution comprising a salt of 3-hydroxypropionic acid to bipolar membrane electrodialysis to convert the salt of 3-hydroxypropionic acid into the free acid of 3-hydroxypropionic acid, and recovering the free acid of 3-hydroxypropionic acid.

2. A process for separating and recovering 3-hydroxypropionic acid, comprising:
(a) subjecting an aqueous solution comprising a salt of 3-hydroxypropionic acid to concentrating electrodialysis to concentrate the salt of 3-hydroxypropionic acid in the aqueous solution;
(b) subjecting the resulting concentrate to bipolar membrane electrodialysis to convert the salt of 3-hydroxypropionic acid into the free acid of 3-hydroxypropionic acid; and
(c) recovering the free acid of 3-hydroxypropionic acid.

3. The process of claim 2, wherein the aqueous solution is a fermentation broth.

4. The process of claim 3, wherein the fermentation broth is a cell-free fermentation broth.

5. The process of claim 2, wherein the 3-hydroxypropionic acid is produced by a microorganism at a concentration of at least 20 g per liter.

6. The process of claim 2, wherein the salt of 3-hydroxypropionic acid comprises a sodium, potassium, or ammonium cation.

7. The process of claim 2, wherein the pH of the aqueous solution comprising the salt of 3-hydroxypropionic acid is at least 6.5.

8. The process of claim 2, wherein the minimum starting concentration of the salt of 3-hydroxypropionic acid in the concentrating electrodialysis is one whose conductivity is at least 10 mS/cm.

9. The process of claim 2, wherein the concentrating electrodialysis is conducted at a temperature in the range of about 10° C. to about 40° C.

10. (canceled)

11. The process of claim 2, wherein the concentration of the salt of 3-hydroxypropionic acid obtained by concentrating electrodialysis is at least about 100 g/liter.

12. The process of claim 2, wherein the minimum starting concentration of the salt of 3-hydroxypropionic acid during bipolar membrane electrodialysis is one whose conductivity is preferably at least 10 mS/cm.

13. The process of claim 2, wherein the bipolar membrane electrodialysis is conducted at a temperature in the range of about 10° C. to about 40° C.

14. The process of claim 2, wherein the bipolar membrane electrodialysis is conducted at a starting pH that is at least 6.

15. The process of claim 2, wherein the concentration of the free acid of 3-hydroxypropionic acid obtained by bipolar membrane electrodialysis is at least about 300 g/liter.

16. The process of claim 2, wherein the conversion of the salt of 3-hydroxypropionic acid to the free acid of 3-hydroxypropionic acid is at least 90%.

17. The process of claim 2, wherein sodium hydroxide is produced and is recycled to a fermentation for pH control.

18. The process of claim 2, further comprising contacting the 3-hydroxypropionic acid with a catalyst to form acrylic acid.

19. The process of claim 2, wherein the salt of 3-hydroxypropionic acid comprises a sodium cation.

20. The process of claim 2, wherein the concentration of the salt of 3-hydroxypropionic acid obtained by concentrating electrodialysis is at least about 300 g/liter.

21. The process of claim 2, wherein the conversion of the salt of 3-hydroxypropionic acid to the free acid of 3-hydroxypropionic acid is at least 95%.
